(19) United States
(12) Patent Application Publication
(10) Pub. No.: US 2005/0286449 A1
(43) Pub. Date: Dec. 29, 2005

(54) Method for setting guard interval in mobile communication using time division duplexing scheme

(75) Inventors: Hee-Sang Seo, Seoul (KR); Jae-Ho Jeon, Seongnam-si (KR); Jeong-Heon Kim, Anyang-si (KR); Myung-Kwang Byun, Suwon-si (KR); Seung-Joo Maeng, Seongnam-si (KR); Soon-Young Yoon, Seoul (KR); Chi-Woo Lim, Suwon-si (KR); Sie-Joon Cho, Seongnam-si (KR); Young-Bin Chang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/167,666

(22) Filed: Jun. 27, 2005

(30) Foreign Application Priority Data
Jun. 25, 2004 (KR) 48449-2004

(51) Int. Cl. H04B 7/212; H04J 3/06; H04B 7/00; H04J 3/00

(52) U.S. Cl. 370/280; 370/310; 370/503

(57) ABSTRACT

A method for setting a guard interval for distinguishing a transition from a downlink period to an uplink period in a mobile communication system employing a time division duplexing (TDD) scheme, the mobile communication system including a plurality of base stations. The method includes the steps of, simultaneously transmitting by each of the base stations downlink signals from transmission antennas at a first time point based on a processing delay time for a signal to be transmitted; simultaneously receiving by each of the base stations an uplink signal at reception antennas at a second time point; and setting a time interval from the first time point to the second time point as a guard interval for distinguishing a transition from an uplink period to a downlink period.

### PRIORITY

This application claims to the benefit under 35 U.S.C. 119(a) of an application entitled “Method For Setting Guard Interval In Mobile Communication Using Time Division Duplexing Scheme” filed in the Korean Intellectual Property Office on Jun. 25, 2004 and assigned Serial No. 2004-48449, the contents of which are incorporated herein by reference.

### BACKGROUND OF THE INVENTION

1. Field of the Invention

The present invention relates to a mobile communication system, and more particularly to a method for setting a guard interval for transitions between an uplink and downlink in a mobile communication system using a time division duplexing (TDD) scheme.

2. Description of the Related Art

Mobile communication systems have evolved from the first-generation analog system, through the second-generation digital system, to the third-generation IMT-2000 system for providing high-speed multimedia service. Now, a fourth-generation mobile communication system for providing ultra-high speed multimedia service is developing.

Since the fourth generation mobile communication system employs an Orthogonal Frequency Division Multiplexing (OFDM) scheme or an Orthogonal Frequency Division Multiple Access (OFDMA) scheme, a plurality of sub-carriers are used to transmit a physical channel signal, thereby enabling ultra-high speed data transmission.

The communication system employing the OFDMA scheme includes a portable Internet service, hereinafter referred to as a wireless broadband (WiBro) system. According to the WiBro system, a mobile station can access the internet at an ultra-high speed in 2.3 GHz frequency band while it is moving. The WiBro system operates by employing a time division duplexing (TDD) scheme combined with the OFDMA scheme.

In the TDD scheme, an uplink and a downlink exist and the whole frequency band is dividedly used time-by-time. Therefore, the TDD scheme requires a guard interval for distinguishing between the uplink and the downlink.

In current mobile communication systems employing the TDD scheme, the guard interval may be classified as a transmit/receive transition gap (TTG) for distinguishing a transition from a downlink to an uplink and a receive/transmit transition gap (RTG) for distinguishing a transition from an uplink to a downlink. However, up to now, a specific standard for defining the guard interval has not been proposed. Therefore, a signal of a mobile station located around a cell boundary may act as an interference signal to a neighbor base station, depending on the scheme defining the guard interval.

### SUMMARY OF THE INVENTION

Accordingly, the present invention has been made to solve the above-mentioned problems occurring in the prior art, and an object of the present invention is to provide a method for efficiently setting a guard interval (TTG/RTG) for transitions between an uplink and a downlink in a mobile communication system employing a time division duplexing scheme.

Another object of the present invention is to provide a method for setting a guard interval (TTG/RTG) between an uplink and a downlink on the basis of transmission/reception time points of antennas in order to reduce inter-carrier interference in a mobile communication system employing a time division duplexing scheme.

Still another object of the present invention is to provide a method and a system for setting a guard interval (TTG/RTG) between uplink and downlink while maintaining frame synchronization between base stations.

To accomplish these objects, in accordance with one aspect of the present invention, there is provided a method for setting a guard interval for distinguishing a transition from a downlink period to an uplink period in a mobile communication system employing a TDD scheme, the mobile communication system including a plurality of base stations. The method includes the steps of simultaneously transmitting by each of the base station downlink signals from transmission antennas at a first time point based on a processing delay time for a signal to be transmitted; simultaneously receiving by each of the base stations an uplink signal at reception antennas at a second time point; and setting a time interval from the first time point to the second time point as a guard interval for distinguishing a transition from an downlink period to an uplink period.

In accordance with another aspect of the present invention, there is provided a method for setting a guard interval for distinguishing a transition from a downlink period to an uplink period in a mobile communication system employing a TDD scheme, the mobile communication system including a plurality of base stations. The method includes the steps of determining, by each of the base stations, a first time point at which downlink signal transmission ends at transmission antennas; determining, by each of the base stations, a second time point at which uplink signal reception starts at reception antennas; and setting a time interval from the first time point to the second time point as a guard interval for distinguishing a transition from a downlink period to an uplink period.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a transmitter in a mobile communication system employing a time division duplexing (TDD) scheme according to an embodiment of the present invention;

FIG. 2 is a block diagram illustrating a configuration of a receiver in a mobile communication system employing the TDD scheme according to an embodiment of the present invention;

FIG. 3 is a diagram for explaining influence exerted upon a cell radius depending on methods for setting a guard interval (TTG) in accordance with an embodiment of the present invention;

FIG. 4 is a diagram for explaining a problem caused by a transmission delay and a signal processing delay when a TTG is set based on transmission/reception time points of modems in a mobile communication system employing the TDD scheme;

FIG. 5 is a diagram for explaining the case in which a TTG is set based on transmission/reception time points of antennas in a mobile communication system employing the TDD scheme according to an embodiment of the present invention;

FIG. 6 is a diagram for explaining a signal interference phenomenon occurring when a TTG is set based on modems in a mobile communication system employing the TDD scheme;

FIG. 7 is a diagram for explaining a TTG set-up based on signal transmission/reception time points of antennas and an RTG set-up based on the set TTG in a mobile communication system employing the TDD scheme according to an embodiment of the present invention; and

FIG. 8 is a diagram for explaining synchronization for the whole frame when a TTG is set based on signal transmission/reception time points of modems in a mobile communication system employing the TDD scheme.

### DETAILED DESCRIPTION OF THE PREFERRED EMBODIMENT

Hereinafter, one preferred embodiment according to the present invention will be described with reference to the accompanying drawings. In the following description of the embodiments of the present invention, a detailed description of known functions and configurations incorporated herein will be omitted when it may obscure the subject matter of the present invention.

The present invention may be applied to a mobile communication system employing a time division duplexing (TDD) scheme. In the following description according to an embodiment of the present invention, a method for setting a guard interval (transmit/receive transition gap & receive/transmit transition gap; TTG/RTG) for distinguishing between an uplink period and a downlink period will be explained. Particularly, the present invention will be described in detail in relation to a method for setting the guard interval based on signal transmission of transmission antennas and signal reception of reception antennas.

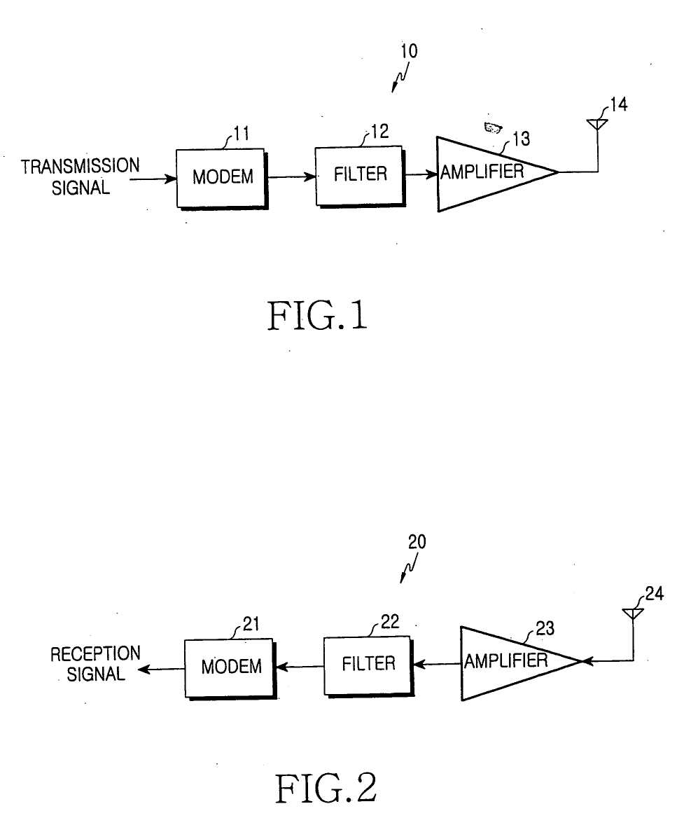

FIG. 1 is a block diagram illustrating a configuration of a transmitter in a mobile communication system employing the TDD scheme according to an embodiment of the present invention.

Referring to FIG. 1, the transmitter 10 encodes a signal to be transmitted by means of a modem 11 and removes a noise component included in the signal by a filter 12. The signal, from which the noise component has been removed, is amplified by an amplifier 13 and is transmitted through an antenna 14. In this case, during such a signal processing procedure, a signal processing time delay occurs in each of the devices.

FIG. 2 is a block diagram illustrating a configuration of a receiver in a mobile communication system employing the TDD scheme according to an embodiment of the present invention.

Referring to FIG. 2, the receiver 20 receives a signal transmitted from a transmission side through an antenna 24, amplifies the received signal by an amplifier 23, removes a noise component of the amplified signal by various filters 22, and then demodulates and decodes the received signal by a modem 21. In this case, while the received signal is passing through the amplifier 23 (such as a low noise amplifier having a low noise figure and a high gain) and the various filters 22, a processing time delay occurs.

As described with reference to FIGS. 1 and 2, both the transmitter 10 and the receiver 20 include many devices (e.g., a surface acoustic wave (SAW) filter (not shown), an intermediate frequency (IF) filter (not shown), a frequency synthesizer (not shown), an amplifier) between a modem and an antenna. A delay time, caused by the multiple devices, is in the rough order of μs, so that the entire consumption delay time occurring in such a way may cause performance deterioration in a system using a cyclic prefix of about 10 μs.

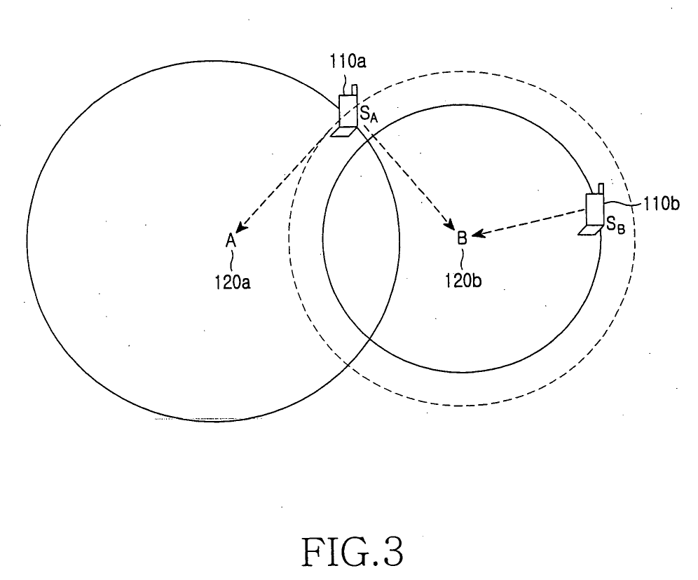

FIG. 3 is a diagram for explaining the influence exerted upon a cell radius depending on methods for setting a guard interval (TTG) in accordance with an embodiment of the present invention. In general, when the TTG is set, a round trip delay from a base station to a mobile station is reflected. That is, a cell radius is determined by a mobile terminal located at a position at which the mobile terminal receives a signal of the base station and then can transmit an uplink signal within the TTG time. In the case of a mobile terminal located out of a cell radius, although the mobile station transmits an uplink signal after receiving a downlink signal of a base station, the transmitted uplink signal cannot arrive at the base station within the TTG time, so that it can be understood that the mobile terminal is located out of the service coverage of the relevant base station. FIG. 3 shows a case in which the TTG is set as a small value so as to be the cell radius shown in FIG. 3.

Referring to FIG. 3, two cells are managed by base stations A 120a and B 120b. Mobile station S_{A} 110a is located at a boundary between the two base stations 120a and 120b. Mobile station S_{B} 110b is located at a boundary of base station B 120b. FIG. 3 shows the case in which mobile station SA 110a is synchronized in uplink and downlink with the base stations A 120a, and mobile station S_{B} 110b is synchronized in uplink and downlink with base stations B 120b.

Base station B 120b has delay time due to signal processing which exceeds that of base station A 120a, so that the cell radius may change depending on the set guard intervals (TTG). That is, in FIG. 3, although the cell radius to be managed by base station B 120b is a radius corresponding to a circle illustrated by a dotted line, the cell radius of base station B 120b decreases as the guard interval (TTG) is set based on modems, so that it becomes a radius corresponding to a circle illustrated by a solid line. A method for setting the guard interval on the basis of modems or antennas will be described in detail later.

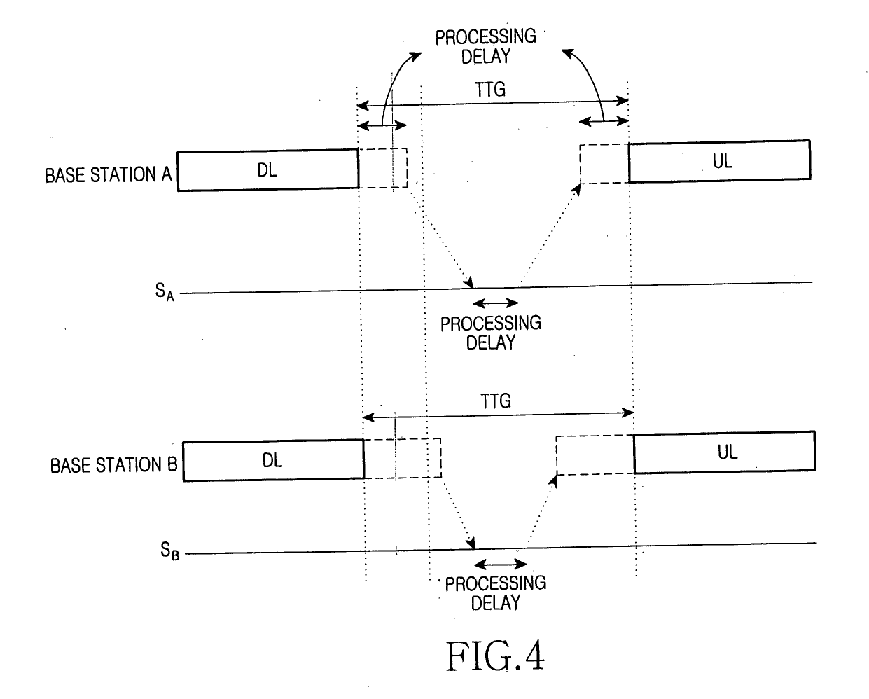

FIG. 4 is a diagram for explaining a problem caused by a transmission delay and a signal processing delay when a TTG is set based on transmission/reception time points of modems in a mobile communication system employing the TDD scheme.

TTGs set in Base stations A and B are based on signal transmission/reception time points of modems. That is, the end time point of a downlink (DL) is a time point referenced to the time at which the signal is transmitted from the modem of base station A or B, and the start time point of an uplink (UL) is a time point at which a signal is received at a modem of base station A or B. In FIG. 4, downlink and uplink periods are illustrated by solid lines.

Herein, as described with reference to FIG. 3, the signal processing delay time caused by devices on the antenna side following a modem in base station A is shorter than that in base station B. That is, in FIG. 4, a dashed-line portion after the end time point of a downlink represents signal processing delay time caused by devices from when a signal is transmitted through a transmission modem to when the signal is transmitted via an antenna, and a dashed-line portion before the start time point of an uplink represents signal processing delay time caused by devices from when a signal is received via an antenna to when the signal is received in a reception modem. Also, in FIG. 4, a time interval from the end point of the downlink dashed-line to the start point of the uplink dashed-line corresponds to the time actually required for a round trip of a signal through the wireless route. Since base stations have the same TTG but require different time intervals for the wireless route round trip, actual cell radiuses may differ depending on the base stations. As shown in FIG. 4, since a processing delay time of base station B is longer than that of base station A, the time interval of the wireless route round trip obtained by subtracting the relevant processing delay time from the entire TTG time in base station B is shorter than that obtained by the same calculation in base station A, so that the cell radius coverable by base station B shortens. Therefore, it is preferable to set the TTG on the basis of transmission/reception time points of antennas rather than on the basis of transmission/reception time points of modems.

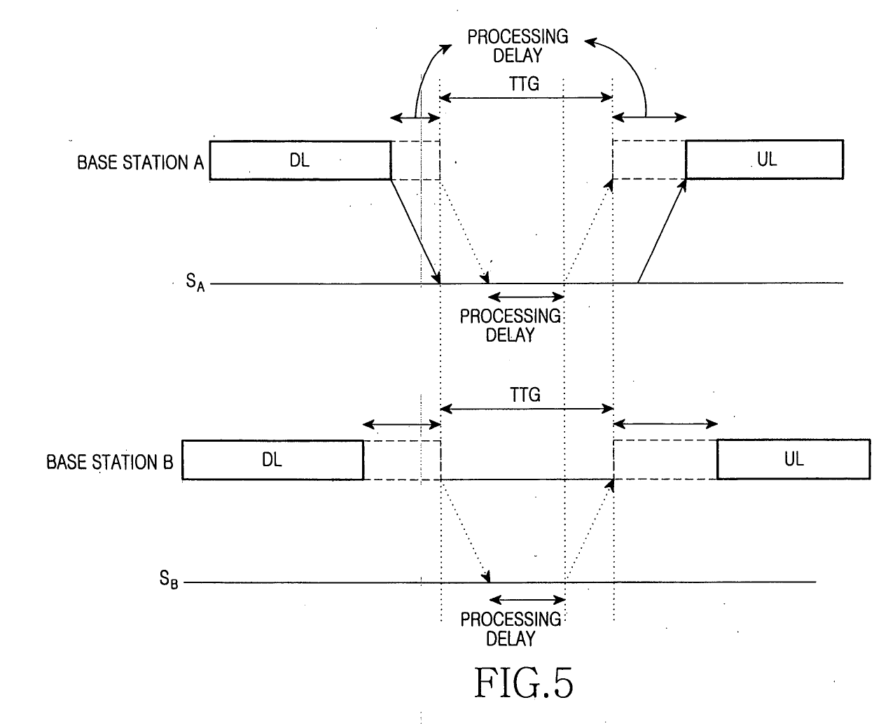

FIG. 5 is a diagram for explaining the case in which a TTG is set based on transmission/reception time points of antennas in a mobile communication system employing the TDD scheme according to an embodiment of the present invention.

Referring to FIG. 5, a dashed-line portion after the end time point of a downlink represents signal processing delay time caused by devices following a transmission modem, and a dashed-line portion before the start time point of an uplink represents signal processing delay time caused by devices preceding a reception modem. That is, it can be understood that the signal processing delay time of base station A is shorter than that of base station B. Therefore, both the base stations synchronize the respective signal transmission time points and the respective signal reception time points at their antennas in consideration of the signal processing delay time of base station A and the signal processing delay time of base station B, and set an interval between the signal transmission time point and the signal reception time point of antennas as a TTG. In this case, the TTG is consumed only by the time interval of the wireless route round trip from a base station to a mobile terminal, which is the same for all base stations. Therefore, when it is assumed that the same delay time occurs in mobile stations S_{A} and S_{B} and also the same transmission delay time occurs in transmitting/receiving a signal in the two mobile stations, the two base stations have an identical cell radius.

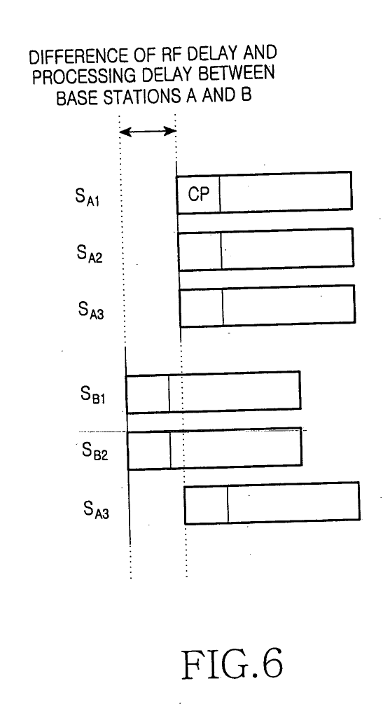

FIG. 6 is a diagram for explaining a signal interference phenomenon occurring when a TTG is set based on modems in a mobile communication system employing the TDD scheme. Herein, the case in which the TTG assumed in FIGS. 3 and 4 limits the cell radius and also a problem occurring in connection with a random TTG will be described.

Referring to FIG. 6, base station A manages mobile stations S_{A1}, S_{A2} and S_{A3}, and base station B manages mobile stations S_{B1} and S_{B2}. Herein, it is assumed that mobile station S_{A3} is located at a cell boundary between the base stations A and B and is spaced by an equal distance from the two base stations A and B. Also, it is assumed that the processing delay time of base station A is ‘0’ and the processing delay time of base station B is ‘T’. In FIG. 6, a first longitudinal dashed-line represents an uplink reception start point of the reception antenna in base station B, and a second longitudinal dashed-line represents the reception start point of modems in base stations A and B. That is, after base station B receives signals of mobile stations at its reception antenna, base station B delays the received signals by the processing delay time of ‘T’ and transmits the received signals to its modem at the same time as the signals are transmitted at the modem of base station A. In order to synchronization in the modem terminal of a base station, mobile terminals belonging to a base station having a long processing delay time must transmit signals to the reception antenna of the relevant base station at a relatively fast speed so that the transmitted signal may arrive at the relevant modem on time after the long processing delay time.

In the case of FIG. 6, a signal transmitted from a mobile station belonging to base station B must arrive at the reception antenna of base station B earlier by ‘T’ than signals of mobile stations belonging to base station A so as to synchronize in modems of base stations. In this case, since mobile station S_{A3} is located at a boundary between the two base stations, an uplink signal of mobile station S_{A3} arrives simultaneously at the reception antennas of the two base stations with the same signal intensity. However, since mobile station S_{A3} is a mobile station in which a transmission time point is set to a reception time point of the modem of base station A, the uplink signal transmitted from mobile station S_{A3} arrives at the modem terminal of base station B later by ‘T’. Consequently, the signal of mobile station S_{A3} arrives later at the modem than the signals of other mobile stations. In this case, when a difference between processing delay times of the two base stations is larger than a cyclic prefix (CP) time, a signal arriving at base station B together with a signal of mobile station S_{A3} after the CP time breaks the orthogonality of signals of mobile stations of base station B in an OFDM system, thereby causing inter-carrier interference, which may be a problem in reception signal demodulation of the base station B. That is, in the case of defining the TTG on the basis of a modem of a base station, a difference between the processing delay times of base stations becomes larger than a predetermined level, all mobile stations spaced by the same distance from the two base stations may cause inter-carrier interference.

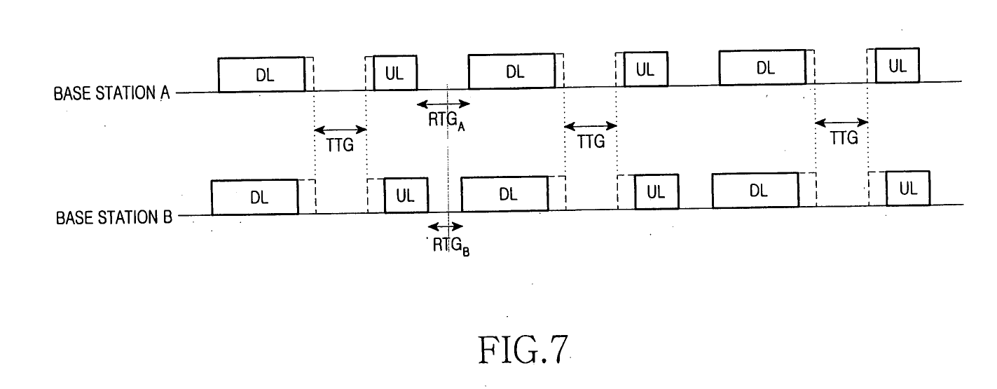

FIG. 7 is a diagram for explaining TTG set-up on the basis of signal transmission/reception time points of antennas and corresponding RTG set-up in a mobile communication system employing the TDD scheme according to an embodiment of the present invention.

Referring to FIG. 7, when a TTG is set based on signal transmission/reception time points of antennas, downlink transmission time points and uplink reception time points in all base stations are synchronized in each frame, respectively. Accordingly, inter-carrier interference does not occur.

According to the present invention, a TTG (a guard interval for a transition from a downlink to an uplink) is set based on signal transmission/reception time points of antennas, and a RTG (a guard interval for a transition from an uplink to a downlink) is set to a time interval from when a modem of a base station receives a signal to when a modem of the base station transmits a downlink signal of a next frame. Herein, the transmission time points of the modem in each base station is determined by measuring a processing delay time according to base stations on the basis of a reference time which all base stations have understood. That is, after each base station measures its own processing delay time, each base station starts modem transmission earlier by the measured processing delay time than the reference time of each frame and then performs a reception operation at the TTG time after transmission though its antenna is completed, so that the transmission and reception time points in all base stations becomes equal. When the TTG is defined on the basis of an antenna, the values of RTGs differ depending on base stations. Therefore, the value of RTG is defined as a time interval from when an uplink reception is completed to when modem transmission for the next frame starts. The reference time includes time provided from a global positioning system (GPS).

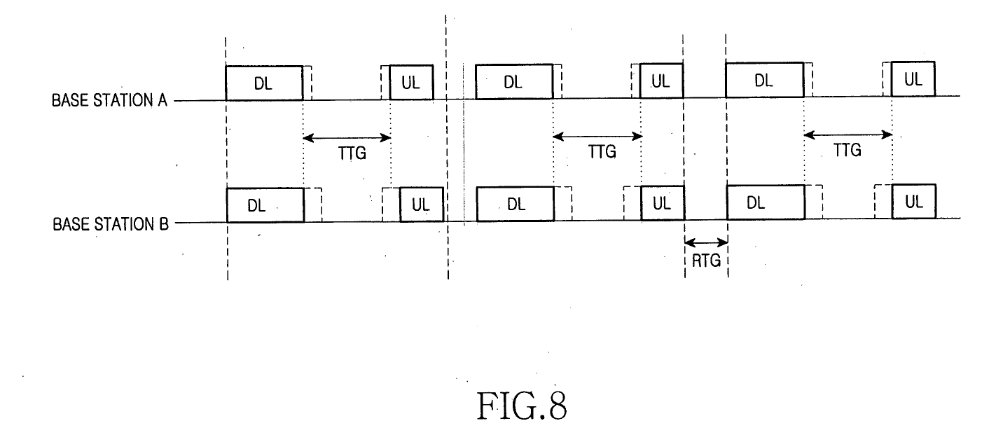

FIG. 8 is a diagram for explaining synchronization for the whole frame when a TTG is set based on signal transmission/reception time points of modems in a mobile communication system employing the TDD scheme.

Referring to FIG. 8, when a TTG is set based on the signal transmission/reception time points of modems, the RTGs of all base stations are set to an equal value. Modems of all base stations simultaneously start signal transmission at a predetermined reference time. Since entire delay time intervals differ depending on the base station, transmission time intervals between transmission and reception antennas differ depending on the base station when a TTG is set based on modems. As a result, a signal transmitted from a mobile station located at the cell boundary may cause inter-carrier interference in uplink transmission of a mobile station included in a neighbor base station.

As described above, according to the embodiments of the present invention, a TTG is set based on signal transmission/reception time points of antennas in a mobile communication system employing the TDD scheme, so that it is possible to acquire synchronization for uplink and downlink signals of all base stations. By such synchronization acquisition, inter-carrier interference can be efficiently removed.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

1. A method for setting a guard interval for distinguishing a transition from an downlink period to a uplink period in a mobile communication system employing a time division duplexing (TDD) scheme, the mobile communication system including a plurality of base stations, the method comprising the steps of:
simultaneously transmitting by each of the base stations downlink signals from transmission antennas at a first time point based on a processing delay time for a signal to be transmitted;
simultaneously receiving by each of the base stations an uplink signal at reception antennas at a second time point; and
setting a time interval from the first time point to the second time point as a guard interval for distinguishing a transition from a downlink period to an uplink period.

2. The method as claimed in claim 1, wherein the first and second time points are determined based on a reference time.

3. The method as claimed in claim 2, wherein the reference time includes time provided from a global positioning system (GPS).

4. The method as claimed in claim 1, wherein the uplink signal is transmitted by a mobile station at a point of time based on the time interval.

5. A method for setting a guard interval for distinguishing a transition from a downlink period to an uplink period in a mobile communication system employing a time division duplexing (TDD) scheme, the mobile communication system including a plurality of base stations, the method comprising the steps of:
determining by each of the base stations a first time point at which downlink signal transmission ends at transmission antennas;
determining by each of the base stations a second time point at which uplink signal reception starts at reception antennas; and
setting a time interval from the first time point to the second time point as a guard interval for distinguishing a transition from a downlink period to an uplink period.

6. The method as claimed in claim 4, wherein the first and second time points are determined based on a reference time.

7. The method as claimed in claim 5, wherein the reference time includes time provided from a global positioning system (GPS).

8. The method as claimed in claim 4 further comprising the steps of:
determining by each of the base stations a third time point at which uplink signal reception ends according to the time interval between the first time point and the second time point.
determining by each of the base stations a forth time point at which downlink signal transmission starts according to the time interval between the first time point and the second time point.
